(19) United States
(12) Patent Application Publication
(10) Pub. No.: US 2015/0123314 A1
(43) Pub. Date: May 7, 2015

(54) PROCESS FOR THE MANUFACTURE OF SHAPE MEMORY POLYMER MATERIAL

(71) Applicant: Smith & Nephew PLC, London (GB)

(72) Inventors: Malcolm Brown, Otley (GB); Horacio Montes de Oca Balderas, Acomb (GB); Michael Andrew Hall, Heslington (GB); Alan William Bull, Clifton Moor (GB); David Franklin Farrar, Heslington (GB); Philip Caton-Rose, Bradford (GB); Philip David Coates, Bradford (GB); Glen Thompson, Bradford (GB); Michael Martyn, Bradford (GB); Ian MacMillan Ward, Leeds (GB); Mark James Bonner, Leeds (GB); Peter John Hine, Leeds (GB); Paul Unwin, Bradford (GB); Michael Woodhead, Bradford (GB)

(73) Assignee: Smith & Nephew PLC, London (GB)

(21) Appl. No.: 14/350,002

(22) PCT Filed: Oct. 5, 2012
(86) PCT No.: PCT/GB2012/052478

§ 371 Date: Apr. 4, 2014

(30) Foreign Application Priority Data
Oct. 5, 2011 (GB) 1117214.5
Oct. 5, 2011 (GB) 1117216.0
Oct. 5, 2011 (GB) 1117217.8
Oct. 5, 2011 (GB) 1117218.6
Oct. 5, 2011 (GB) 1117219.4
Oct. 5, 2011 (GB) 1117220.2
Oct. 5, 2011 (GB) 1117222.8
Oct. 5, 2011 (GB) 1117223.6
Oct. 5, 2011 (GB) 1117224.4
May 29, 2012 (GB) 1209510.5

(51) Int. Cl. B29C 43/52; C08J 5/04

(52) U.S. Cl. CPC B29C 43/52; C08J 5/046; B29K 2101/12
USPC 264/319

(57) ABSTRACT

The present invention relates at least in part to methods for the manufacture of shape memory polymer (SMP) materials. Particularly, although not exclusive, the present invention relates to processes for the formation of complex shaped devices composed of shape memory polymer.

### FIELD OF THE INVENTION

The present invention relates at least in part to methods for the manufacture of shape memory polymer (SMP) materials. Particularly, although not exclusively, the present invention relates to processes for the formation of complex shaped devices composed of shape memory polymer material. The present invention also provides devices and apparatus comprising complex shapes made from the processes described herein as well as devices comprising SMP material and non-SMP material. The SMP material obtainable from the processes of the present invention may have a variety of uses including for example in the production of devices for use in medical applications.

### BACKGROUND TO THE INVENTION

Shape memory polymer devices can be used in a variety of applications including, but not limited to, applications in the field of medical devices. An example of their use is in orthopedic devices, such as screws, tacks, anchors etc. Polymers used for SMP devices in the field of medical devices need be biocompatible, have mechanical and degradation properties suitable for the specific application in which they are used and change shape at a suitable temperature, and often be resorbable and the like to aid with fixation etc.

Shape memory polymers are typically made by “programming” a polymer material, which then later recovers after the application of a stimulus such as heat. Processes such as die drawing, in which the polymer is heated, pushed through a die and then cooled, offer a convenient and cost-effective way of “programming” a SMP. Initially, a polymer is heated above its Tg (glass transition temperature) and mechanically deformed through a die which puts energy and stress into the polymer.

Die-drawing typically requires a polymer billet to be heated and drawn through a die of narrower dimensions thus inducing elongation of the billet and orientation of the polymer chains. The polymer is then quickly cooled, locking the stress in, giving the polymer shape memory properties. The initial shape of the polymer is recovered at a later stage when required by activation of the polymer. Activation can be achieved e.g. by application of heat, raising the temperature of the polymer above its Tg, and so switching the polymer back to its initial shape.

Such processes can be convenient for producing large quantities of SMP rod in a continuous fashion. However these methods are limited in that they can only produce materials with a constant cross-section. Therefore, in order to produce devices with a complex shape for example screws, tacks, anchors and the like, further processes are required to produce the desired shape of these devices.

Devices may be machined from the programmed SMP rod. However, machining typically heats the polymer and this heating can trigger the SMP to change shape back to its initial pre-programming shape. This is particularly a problem when the SMP material has a low glass transition temperature (Tg). Polymers with low Tg are often used in medical devices as it is often desired that the SMP shape change is triggered in the body (i.e. at around 37° C.).

Prior art methods have also used expansion moulding to produce shape memory polymer devices with complex shapes. However, expansion moulding generally requires partial activation of the SMP material resulting in some loss of the shape memory properties.

Other methods of producing and programming shape memory polymers include heating the polymer followed by simple deformations such as stretching, bending, twisting and the like of a simple shape such as a fibre, rod, bar or tube. Similarly, however, such methods cannot produce complex polymer shapes.

Shape memory polymer (SMP) devices can be used in a variety of applications including, but not limited to, medical device applications. An example of their use is in orthopedic implant applications. In many cases such devices require cannulation; the cannulation being for the use of a guide-wire (particularly for endoscopically delivered devices) or, in the case of devices such as screws or anchors that are driven into bone, the cannulation may also serve to take the driver. In this latter case the cannulation may require a non-circular cross-section such as a hexagon or spline. In all these cases the cannulation in the device requires a precise cross-section in size and/or shape. However, creating such a cannulation in a shape-memory polymer, particularly a shaped cannulation, is problematical.

If the cannulation is present in the initial shape of the polymer before programming then it is very likely that the detail of its shape will be lost during the programming of the polymer, as this stage involves a high degree of deformation of the polymer.

Typically, an insert, e.g. a guidewire or driver is inserted into the cannulation of the device when the polymer is in its temporary programmed shape. Thus, the cannulation must be a precise shape, suitable for implantation in this temporary shape and suitable for accommodating an insert.

An alternative approach would therefore be to add a cannulation after programming of the polymer to give the shape memory properties. This could be done by a process such as drilling, machining or broaching. However, such processes produce heat and are prone to induce recovery of the SMP, especially when the activation temperature of the SMP is low such as is required for medical implants.

Thus, there remains a need for methods to produce complexly shaped devices which comprises a SMP material component e.g. screws, cannulated devices and the like with shape memory properties. There also remains a need for methods to produce devices which comprise an SMP material component and a non-SMP component.

It is an aim of embodiments of the present invention to at least partly mitigate the aforementioned disadvantages associated with prior art methods.

### SUMMARY OF THE INVENTION

Embodiments of the present invention relate to methods of producing devices, components and apparatus which comprise a Shape Memory material. Particularly, although not exclusively, embodiments of the present invention relate to devices, components and apparatus which comprise a shape memory polymer material. Also included in the present invention are devices which comprise a non-SMP material component, that is to say, a component which does not have shape memory properties, in addition to an SMP material component.

In one aspect of the present invention, there is provided a method of manufacturing a component comprising a shape memory polymer material or a device comprising a shape memory polymer material, the method comprising applying a predetermined pressure to a polymer material prior to, at substantially the same time or subsequent to programming the polymer material to impart shape memory properties to the polymer material.

Aptly, the method comprises placing a polymer material in a mould and applying pressure thereto.

Aptly, the method comprises;
programming the polymer material to impart shape memory properties thereto and form an SMP material;
placing the SMP material into a mould; and
applying the predetermined pressure to the mould.

Aptly, the pressure is applied to the mould by a process of cold forging at a temperature below the glass transition temperature of the SMP material and wherein the temperature maintains the molecular orientation of the polymer of the SMP material.

Aptly, the steps of placing the SMP material into a mould and applying a pressure to the mould are repeated one, two, three, four or more times, and wherein flash is removed between each mouldings. In one embodiment, the step of applying the pressure alters the dimensions of the SMP material.

Aptly, the method comprises heating or cooling the mould before and/or at substantially the same time as applying the pressure to the mould.

Aptly, the step of applying pressure comprises closing the mould with a hydraulic press.

Aptly, the method is for forming a complex shaped component.

Aptly, the method is a method of making a device comprising a channel of fixed dimensions, wherein the device comprises a shape memory polymer material, wherein the method comprises fixing the dimensions of the channel at substantially the same time as programming the SMP material. In one embodiment, the method comprises forming an initial channel in the polymer material and drawing the channeled polymer material through a die comprising a mandrel.

Aptly, the dimensions of the channel of the SMP material are provided by the dimensions of the mandrel.

Aptly, the channel of the SMP material device comprises a cross section selected from a circle, an oval, a triangle, a square, a rectangle, a hexagon, a spline, a star and a cross. As used herein, the term “channel” may be interchangeable with the term “cannulation”.

Aptly, the method comprises forming a billet of the polymer material by a process selected from compression moulding, injection moulding, ram injection moulding and extrusion.

Aptly, the method is a method of forming a component or device comprising a composition comprising a matrix and SMP material fibers, the method comprising:
a. applying the predetermined pressure to an assembly of SMP material fibers;
b. heating the assembly of polymer material fibers to a first predetermined temperature sufficient to melt or soften at least a portion of the fibers, wherein the first predetermined temperature is greater than the glass transition temperature of the polymer material; and
c. cooling the fibers to form the composition comprising a matrix and SMP material fibers.

Aptly, the method comprises orientating the polymer fibers in different directions.

Aptly, the method comprises mixing the SMP fibers with non-SMP fibers.

In one embodiment, the SMP fibers are tapes. Aptly, the method comprises melting or softening an outer layer of a portion of the SMP fibers.

Aptly, the assembly of polymer material fibers comprises a second polymer type, wherein the second polymer type has a different glass transition temperature to the first polymer type.

In an embodiment, the method comprises programming the polymer material to impart shape memory properties at substantially the same time as a step of shaping the polymer material.

Aptly, the method comprises:
a. heating the polymer material to a first predetermined threshold temperature prior to or at the same time as applying the predetermined pressure, wherein the predetermined pressure is applied so as to change an initial shape of the polymer material to a predetermined second shape;
b. feeding the polymer material through a die to form an SMP material component; and
c. cooling the SMP component to a second predetermined threshold temperature.

Aptly, the first predetermined threshold temperature is above the glass transition temperature of the polymer material and/or the second predetermined threshold temperature is below the glass transition temperature of the polymer material.

Aptly, the step (b) comprises ram extrusion and/or compression transfer moulding. In one embodiment, the second predetermined threshold temperature is below the glass transition temperature of the polymer material.

In one embodiment, the method is a method for forming a device comprising a SMP material component and a non-SMP material component, the method comprising moulding one or more non-SMP components onto a surface of an SMP component. Aptly, the method comprises injection moulding a non-SMP component onto a surface of an SMP component.

As used herein, the term “non-SMP material” is taken to include materials which do not possess shape memory qualities, i.e. do not change shape back towards an initial shape when heated or otherwise activated. Examples of such materials are described herein. Aptly, the non-SMP material may be a polymer which has not undergone programming to impart shape memory qualities thereto. Aptly, the non-SMP material comprises a plastic e.g. a moulded plastic.

Aptly, the method comprises a first step of programming the polymer material to form the SMP material component. Aptly the method comprises placing the SMP material component in a mould and injection moulding the non-SMP material into the mould to form the device, and wherein the predetermined pressure is applied upon injection of the non-SMP material into the mould.

In one embodiment, the method comprises moulding a non-continuous layer of non-SMP material onto a surface of the SMP material component.

Aptly, the SMP material component comprises a channel, and the method comprises moulding the non-SMP material to an inner surface of the channel of the SMP material component. Aptly, the device comprises more than one SMP material component and/or more than one non-SMP material component.

In one embodiment, the SMP component is replaced by a Shape Memory Metal.

Aptly, the method is for the manufacture of a screw, tack and/or anchor device.

In a further aspect of the present invention, there is provided a method of manufacturing a device comprising a Shape Memory Polymer (SMP) material component and a non-SMP material component, the method comprising moulding the non-SMP material component onto a surface of a SMP material component.

The method may comprise injection moulding a non-SMP component onto a surface of an SMP component. Aptly, the method comprises a first step of programming the polymer material to form the SMP material component. In an embodiment, the method comprises placing the SMP material component in a mould and injection moulding the non-SMP material into the mould to form the device, and wherein the predetermined pressure is applied upon injection of the non-SMP material into the mould.

In a further aspect of the present invention there is provided a method of manufacturing a device comprising a Shape Memory Polymer (SMP) material component, the method comprising: placing the SMP material component in a mould and applying a pressure to the mould so as to alter the dimensions of the SMP component. Aptly, the method comprises placing a polymer material in a mould and applying pressure thereto.

Aptly, the method comprises;
programming the polymer material to impart shape memory properties thereto and form an SMP material;
placing the SMP material into a mould; and
applying a pressure to the mould.

In one embodiment, the pressure is applied to the mould by a process of cold forging at a temperature below the glass transition temperature of the SMP material and wherein the temperature maintains the molecular orientation of the polymer of the SMP material. Aptly, the steps of placing the SMP material into a mould and applying a pressure to the mould are repeated one, two, three, four or more times, and wherein flash is removed between each mouldings. Aptly, the step of applying the pressure alters the dimensions of the SMP material.

In one embodiment, the method comprises heating or cooling the mould before and/or at substantially the same time as applying the pressure to the mould. Aptly, the step of applying pressure comprises closing the mould with a hydraulic press.

Aptly, the method is for forming a complex shaped component.

In a further aspect of the present invention, there is provided a method of manufacturing a device comprising a Shape Memory Polymer (SMP) material component and further comprising a channel of fixed dimensions, the method comprising fixing the dimensions of the channel at the same time or substantially the same time as programming a polymer material component so as to impart shape memory properties to the polymer material to form a SMP material component. Aptly, the method is a method of making a device comprising a channel of fixed dimensions, wherein the device comprises a shape memory polymer material, wherein the method comprises fixing the dimensions of the channel at substantially the same time as programming the SMP material.

Aptly, the method comprises forming an initial channel in the polymer material and drawing the channeled polymer material through a die comprising a mandrel. Aptly, the predetermined pressure is applied to the SMP material subsequent to programming.

Aptly, the pressure is applied to the SMP material via a widening punch hole nose being inserted into a cannulation provided in the SMP material component.

Aptly, the dimensions of the channel of the SMP material are provided by the dimensions of the mandrel. In one embodiment, the channel of the SMP material device comprises a cross section selected from a circle, an oval, a triangle, a square, a rectangle, a hexagon, a spline, a star and a cross. Aptly, the method comprises a first step of forming a billet of the polymer material by a process selected from compression moulding, injection moulding, ram injection moulding and extrusion.

In a further aspect of the present invention, there is provided a method of forming a composition comprising a matrix and SMP material fibers, the method comprising applying a predetermined pressure to an assembly of SMP material fibers; heating the assembly of polymer material fibers to a first predetermined threshold temperature sufficient to fuse together at least a portion of the polymer material fibers, and cooling the SMP fibers to form the composition comprising a matrix and SMP material fibers.

Aptly, the method is a method of forming a component or device comprising a matrix comprising SMP material fibers, the method comprising:
a. applying the predetermined pressure to an assembly of SMP material fibers;
b. heating the assembly of polymer material fibers to a first predetermined temperature sufficient to melt or soften at least a portion of the fibers, wherein the first predetermined temperature is greater than the glass transition temperature of the polymer material; and
c. cooling the fibers to form a matrix of SMP material fibers.

Aptly, the method comprises orientating the polymer fibers in different directions. Aptly, the method comprises mixing the SMP fibers with non-SMP fibers. In one embodiment, the SMP fibers are tapes. In an embodiment, the method comprises melting an outer layer of a portion of the SMP fibers. Aptly, the assembly of polymer material fibers comprises a second polymer type, wherein the second polymer type has a different glass transition temperature to the first polymer type.

In a further aspect of the present invention, there is provided a method of manufacturing a device comprising an Shape Memory Polymer material, the method comprising;
a. heating a polymer material component to a first predetermined threshold temperature;
b. applying a predetermined pressure to the polymer sufficient to change an initial shape of the polymer material component to a predetermined second shape;
c. feeding the polymer material component through a die to form an SMP material component; and
d. cooling the SMP component to a second predetermined threshold temperature.

Aptly, the method comprises programming the polymer material to impart shape memory properties at substantially the same time as a step of shaping the polymer material.

Aptly, the method comprises:
a. heating the polymer material to a first predetermined threshold temperature prior to or at the same time as applying the predetermined pressure, wherein the predetermined pressure is applied so as to change an initial shape of the polymer material to a predetermined second shape;
b. feeding the polymer material through a die to form an SMP material component; and
c. cooling the SMP component to a second predetermined threshold temperature.

Aptly, the first predetermined threshold temperature is above the glass transition temperature of the polymer material and/or the second predetermined threshold temperature is below the glass transition temperature of the polymer material. Aptly the step (b) comprises ram extrusion and/or compression transfer moulding.

Aptly, the SMP material comprises a polymer selected from poly(L-lactide) poly(D,L-lactide), polyglycolide, polycaprolactone, polydioxanone or a blend or copolymer thereof.

Aptly, the SMP material comprises a polymer selected: polyurethane, polyacrylate such as poly(methyl-methacrylate), poly(butyl methacrylate), poly(ether ether ketone) (PEEK) or a blend or copolymer thereof.

In one embodiment, the SMP material comprises filler particles. The filler particles may be organic or inorganic. Aptly the filler particles comprise a bioceramic filler e.g. calcium phosphate (including tricalcium phosphate, hydroxyapatite, brushite, octacalcium phosphate), calcium carbonate, calcium sulphate, or a bioglass.

Aptly, the SMP material further comprises a pharmaceutically active agent or other bioactive agent e.g. a growth factor, an osteogenic factor, an angiogenic factor, an anti-inflammatory agent, an antibiotic and/or an antimicrobial.

Aptly, the SMP material comprises a plasticiser. Plasticisers or mixtures thereof suitable for use in the present invention may be selected from a variety of materials including organic plasticisers and those that do not contain organic compounds.

Aptly, the plasticiser is selected from DL-lactide, L-lactide, glycolide, ε-Caprolactone, N-methyl-2-pyrolidinone and a hydrophilic polyol e.g. poly(ethylene) glycol (PEG) and combinations thereof.

Plasticisers or mixtures thereof suitable for use in the present invention may be selected from a variety of materials including organic plasticisers and those that do not contain organic compounds.

Aptly, the plasticiser is an organic plasticiser e.g. a phthalate derivatives such as dimethyl, diethyl and dibutyl phthalate; a polyethylene glycol with a molecular weight e.g. from about 200 to 6,000, glycerol, glycols e.g. polypropylene, propylene, polyethylene and ethylene glycol; citrate esters e.g. tributyl, triethyl, triacetyl, acetyl triethyl, and acetyl tributyl citrates, surfactants e.g. sodium dodecyl sulfate and polyoxymethylene (20) sorbitan and polyoxyethylene (20) sorbitan monooleate, organic solvents such as 1,4-dioxane, chloroform, ethanol and isopropyl alcohol and their mixtures with other solvents such as acetone and ethyl acetate, organic acids such as acetic acid and lactic acids and their alkyl esters, bulk sweeteners such as sorbitol, mannitol, xylitol and lycasin, fats/oils such as vegetable oil, seed oil and castor oil, acetylated monoglyceride, triacetin, sucrose esters, or mixtures thereof.

Aptly, the plasticiser is selected from a citrate ester; a polyethylene glycol and dioxane.

In a further aspect of the present invention, there is provided a device obtainable by a method as described herein. Aptly, the device is for medical and/or surgical use.

Aptly, the device is a complex shaped device. Aptly, the device is a screw, a tack or a tissue anchor.

Embodiments of the present invention relate to a shape-memory device comprising a pre-programmed shape-memory component and features moulded onto this component comprising a non-shape-memory polymer. The device may be for medical purposes. Aptly, the device is for implantation in a patient. The device may be resorbable or non-resorbable.

Further details of SMP materials and devices can be found in our co-pending patent applications which share a common priority to the present application and the contents of which are hereby incorporated herein by reference in their entirety.

In addition, embodiments of the present invention relate to a process for producing such a device in which the device is produced by taking a pre-programmed shape-memory component and non-shape memory features over-moulded onto the shape-memory component.

### BRIEF DESCRIPTION OF DRAWINGS

Embodiments of the present invention will now be described hereinafter, by way of example only, with reference to the accompanying drawings in which:

FIG. 1 is a schematic diagram of the shape memory effect;

FIG. 2 is a schematic cross sectional view of two apparatus used to apply pressure to a polymer material component. FIG. 2A shows compression transfer moulding and FIG. 2B shows ram extrusion;

FIG. 3 is a schematic cross section view of an apparatus used in Example 6. The apparatus 100 includes a blanking plate 102, a piston 104 and walls 106 and 108 which radially shape the SMP device;

FIG. 4 is a schematic cross section view of a split die apparatus used in Example 8. The split die apparatus 200 includes a punch nose locating hole 202. The apparatus also includes a punch 204. The nose is located in the lower part of the die and forms a narrow tip. The punch broadens over its length. The apparatus also includes a two pillar die sat spring 206 and a cube due block 208. The punch nose is inserted into a cannulation provided in an SMP component in a mould, here a threaded mould. The widening punch imparts a pressure on the SMP material component and forces the SMP material component against the sides of the mould thus imparting a threaded outer surface to the SMP material component whilst also enlarging the cannulation.

FIG. 5 is a view from above of an apparatus (e.g. a mould) used in Example 9 and Example 12;

FIG. 6 is a top view of an upper part of the apparatus (e.g. a mould) of FIG. 5;

FIG. 7 is a schematic cross sectional view of a step described in Example 13;

FIG. 8 is a view from above of mandrels used in Example 14;

FIG. 9 shows cannulated devices of embodiments of the present invention as described in Example 14;

FIG. 10 is a schematic diagram of the process of hot compaction as used in embodiments of the present invention;

FIG. 11 is a photograph of devices obtainable by a method of hot compaction as described herein;

FIG. 12 is a graph showing % recovery and transverse strength of devices shown in FIG. 11;

FIG. 13 is a photograph of a mould used in Example 10;

FIG. 14 is a photograph of 10 pcf and 20 pcf Sawbones blocks showing >2.5 cm spacing of screw holes as shown in Example 10;

FIG. 15 is a photograph of a pull out method used in Example 11;

FIG. 16 is a photograph of an apparatus used for pull out testing in Example 11;

FIG. 17 is a photograph of a bone sample fastened in a “Christmas tree” fixture as described in Example 11;

FIG. 18 is a graph showing the results of the pull out testing in a tibia as described in Example 11;

FIG. 19 is a graph showing the results of the pull out testing in a femur as described in Example 11;

FIG. 20 illustrates devices of embodiments of the present invention as described in Example 12;

FIG. 21 illustrates examples of apparatus used to overmould non-SMP components to SMP components;

FIG. 22 illustrates an overmould tool as used in Example 1. The overmould tool is composed of two square plates (150 mm×150 mm). The plates are approximately 12 mm thick. An upper plate includes a central sprue and four locating pins which correspond to four locating orifices on the lower plate. The bottom plate and the upper plate both include a cavity which when the plates are brought together are shaped to define the device shape.

FIG. 23 illustrates an overmould tool as used in Example 1. In particular, FIG. 23 shows the cavity of FIG. 22 in the lower plate. The cavity forms a chamber into which an SMP component is placed. The SMP component does not entirely fill the mould and the non-SMP material is injected into the mould, thus flowing around the SMP material component. In the embodiment shown in FIG. 23, the chamber has a diameter of approximately 6 mm and an 8 mm diameter central section. The chamber includes a pair of ejector pins, one at the head of the cavity and one at the foot of the cavity. The chamber is provided with a sprue and a Z pin ejector pin at the sprue;

FIG. 24 illustrates devices made in Example 1;

FIG. 25 illustrates a device made as described in Example 2 in a pre-relaxed form and post-relaxed form;

FIG. 26 illustrates an apparatus used to make a device as used in Example 2;

FIG. 27 illustrates a device made as described in Example 2 in a pre-relaxed form and post-relaxed form;

FIG. 28 is an electron micrograph of a screw made as described in Example 2;

FIG. 29 illustrates a device made as described in Example 3 in a pre-relaxed form;

FIG. 30 illustrates a device made as described in Example 3 in a pre- and post-relaxed form;

FIG. 31 illustrates alternative devices 30 comprising non-SMP material components and SMP material components in which the SMP material component is indicated by numeral 7 and the non-SMP material component is indicated by numeral 9;

FIG. 32 illustrates alternative devices 30 comprising non-SMP material components and SMP material components in which the SMP material component is indicated by numeral 7 and the non-SMP material component is indicated by numeral 9; and

FIG. 33 illustrates alternative devices 30 comprising non-SMP material components and SMP material components in which the SMP material component is indicated by numeral 7 and the non-SMP material component is indicated by numeral 9.

### DETAILED DESCRIPTION OF THE INVENTION

Certain aspects and embodiments of the present invention are described below.

Aptly, the methods of embodiments of the present invention can be used to make complex shaped devices. The term “complex” as used herein refers to shapes which cannot be obtained simply by die drawing processes and the like. Complex shaped devices may include for example threaded devices e.g. screws. Methods of embodiments of the present invention can also be used to manufacture devices which comprise non-uniform i.e. non-constant cross-section e.g. tacks, anchors, suture anchors, screws, clips, dental implants, fracture plates, intramedullary rails and the like.

As used herein, the terms “relax” and “relaxation” refers to the shape change the SMP material undergoes following activation i.e. towards its original pre-programmed state. The terms “relax” and “relaxation” will be understood by the person skilled in the art to be interchangeable with the terms “recover” and “recovery”.

In certain embodiments, the processes described herein may be combined to form a device comprising an SMP material component. For example, a method of imparting shape memory properties to a polymer material component e.g. cold forging, ram extrusion and/or compression injection moulding can be combined with a method of overmoulding as described herein to form a device comprising one or more SMP material components and one or more non-SMP material components.

In certain embodiments, one or more methods may be combined to form a complex shaped device. For example, a method of ram extrusion and/or compression injection moulding to form an SMP material component may be followed by a method comprising cold forging the SMP material component to change the shape of the SMP material component so as to form a device of predetermined dimensions e.g. a screw or tack.

Aptly, the method of embodiments of the present invention comprises the use of an initial polymer material component. Aptly, the polymer material component, prior to programming to impart shape memory properties, is in the form of a billet. The initial polymer billet can be made using processes known in the art such as for example: compression moulding, injection moulding, ram injection moulding and/or extrusion.

Aptly the SMP material components of embodiments of the present invention may be resorbable or non-resorbable.

Aptly, the SMP material comprises a resorbable polymer. Aptly, the SMP material comprises an amorphous polymer. Aptly, the resorbable polymer is selected from polyesters including for example poly(L-lactide) poly(D,L-lactide), polyglycolide, polycaprolactone, polydioxanone or any blend or copolymer of these.

In one embodiment, the SMP material comprises a co-polymer comprising poly(L-lactide). In one embodiment, the SMP material comprises a co-polymer comprising polyglycolide. In one embodiment, the SMP material comprises a co-polymer comprising polycaprolactone.

Aptly, the SMP material comprises a non-resorbable polymer. Examples of non-resorbable polymers include: polyurethane, polyacrylate such as poly(methyl-methacrylate), poly(butyl methacrylate), poly(ether ether ketone) (PEEK) or any blend or copolymer of these.

Aptly, the SMP material comprises between 0.5% and 40% w/w, optionally 5% to 35% w/w of an inorganic filler e.g. Hydroxylapatite, Calcium phosphate, Calcium sulphate, Calcium carbonate or related additives.

In one embodiment, the SMP material comprises Poly(L-co-DL-lactide). Aptly, the SMP material comprises about 70% L-lactide and about 30% DL-Lactide.

Aptly, the SMP material is resorbable, e.g. a polyester including random co-polymers containing between 85 to 90% mol/mol Poly(L-lactide) and 15 to 10% mol/mol of poly(D-lactide) polyglycolide, polycaprolactone, polydanoxanone, or containing 70 to 80% mol/mol Poly(L-lactide) and 20 to 30% of poly(DL-lactide).

Aptly, the SMP material comprises between about 85 to 90% mol/mol Poly (L-lactide) and between about 15-10% poly(D-lactide). Aptly, the SMP material comprises between about 85 to 90% Poly (L-lactide) and between about 15-10% polyglycolide.

Aptly, the SMP material comprises between about 85 to 90% Poly (L-lactide) and between about 15-10% polycaprolactone.

Aptly, the SMP material comprises between about 85 to 90% by weight Poly (L-lactide) and between about 15-10% by weight polydanoxanone.

Aptly, the SMP material comprises a pharmaceutical active agent or other bioactive agent e.g. a growth factor, an osteogenic factor, an angiogenic factor, an anti-inflammatory agent, and/or an antimicrobial agent.

Suitable bioactive agents include for example bone morphogenic proteins, antibiotics, anti-inflammatories, angiogenic factors, osteogenic factors, monobutyrin, omental extracts, thrombin, modified proteins, platelet rich plasma/solution, platelet poor plasma/solution, bone marrow aspirate, and any cells sourced from flora or fauna, such as living cells, preserved cells, dormant cells, and dead cells.

It will be appreciated that other bioactive agents known to one of ordinary skill in the art may also be used. Aptly, the active agent is incorporated into the polymeric shape memory material, to be released during the relaxation or degradation of the polymer material. Advantageously, the incorporation of an active agent can act to combat infection at the site of implantation and/or to promote new tissue growth.

Aptly, the SMP material comprises filler particles, which may be organic or inorganic. In particular, the SMP material comprises a bioceramic filler such as, for example, calcium phosphate (including tricalcium phosphate, hydroxyapatite, brushite, octacalcium phosphate), calcium carbonate, calcium sulphate, or a bioglass.

Aptly, the composition comprises approximately 0.5% or greater by weight of a filler as described herein. Aptly, the SMP material comprises 0.5%, 1%, 2%, 5%, 10%, 15%, 20%, 25%, 30%, 35%, 40% or greater by weight of a filler.

The polymer may also include a plasticiser to modify the glass transition temperature.

The shape memory polymer component can be programmed by processes such as die drawing, zone drawing, hydrostatic extrusion, rolling, roll drawing, ram extrusion, compression moulding or any other solid phase deformation process or combination of these that induces molecular orientation in the polymer.

In one aspect of the present invention, there is provided a method of producing and programming shape memory polymer devices by:
a) heating a billet of the polymer;
b) applying a compressive force in such a way as to change the shape of the polymer to a desired new shape and induce orientation of the polymer chains by forcing the polymer into or through a die, and
c) cooling the polymer below its Tg

Aptly, the polymer billet is heated above its glass transition temperature.

Aptly, the method comprises a further step of altering the shape of the device. For example, processes may be combined, or additional processes may be used, to further alter the shape of the device. For example, a programmed SMP cylinder could be produced by ram extrusion or compression transfer moulding and then converted to a screw, or other complex shape, by e.g. cold forging.

These processes can be carried out at an industrial, commercially viable scale. Compared with simple stretching, bending, twisting and the like, complex shapes can be formed programmed with shape memory properties e.g. screws, tacks, anchors and the like.

This route can avoid the need to form complex shapes by machining, milling and the like, which are processes which tend to heat the polymer and can therefore lead to triggering of the shape memory effect, especially in devices with low trigger temperatures (compatible with implantation in the body) such as those used in many medical devices.

Embodiments of the present invention relate to a shape-memory device comprising a pre-programmed shape-memory component that is then further shaped below its transition temperature by a process of cold forging.

Aptly, the process is for producing such a device in which the device is produced by taking a pre-programmed shape-memory component and adding additional shaped features by a process of cold forging.

In one embodiment, there is provided a process for making a shape memory device whereby:
a polymer is given a first shape. It is then given a second shape, different from the first, by a process that induces orientation of the polymer molecules. The polymer is then given a third shape by applying compression within a mould such that substantial orientation of the polymer molecules, and hence shape memory properties, are preserved.

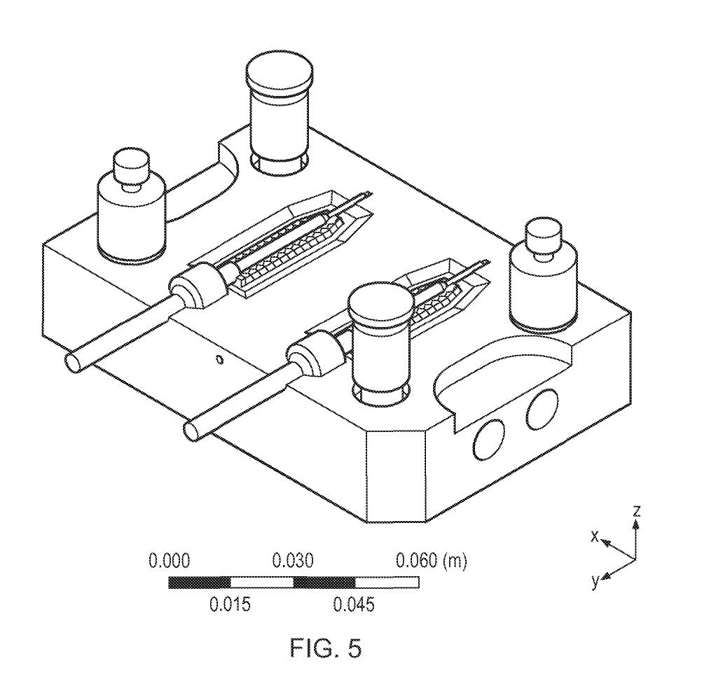

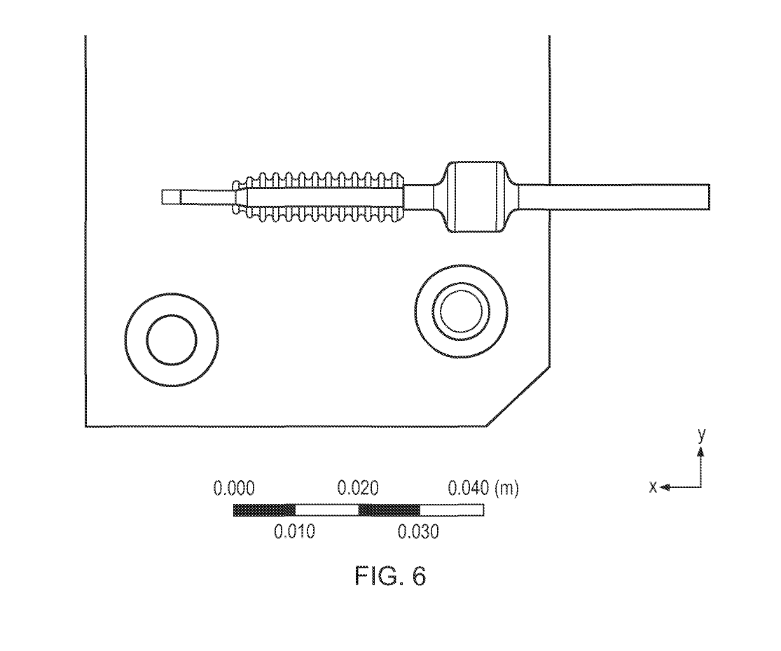

The mould may be heated and/or cooled in order to optimise the moulding conditions. The preform shape may also be changed to optimise filling of the mould and reduce flash—examples suitable for the screw mould are shown in FIG. 5 and FIG. 6. The preform could be changed to give an approximate fit e.g. putting a cone shape on the end of a screw, for example.

In comparison with the use of machining techniques for forming shaped SMPs, the method of embodiments of the invention which comprise the use of a mould, do not heat the polymer in an uncontrolled way. Machining can heat the polymer triggering the shape change—especially in medical devices which are designed to have a trigger temperature that is relatively low. Compared with other methods of making SMP devices this method can be used to impart complex shapes and geometries.

Embodiments of the present invention relate to methods of producing a cannulated device comprising an SMP material component. Die-drawing is a process that can be used to produce oriented polymers with enhanced mechanical properties. It is a solid state deformation process whereby a polymer billet is heated and drawn through a die of narrower dimensions thus inducing elongation of the billet and orientation of the polymer chains.

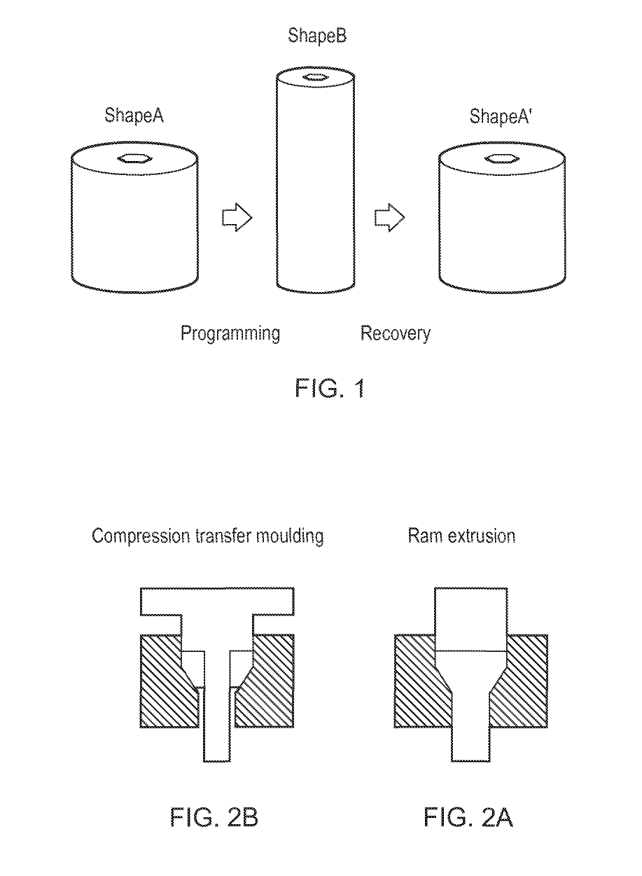

The invention provides, at least in part, a process for producing a shape memory material with a cannulation or channel of fixed shape and/or dimensions whereby the shape of the cannulation is fixed at the same time as the programming of the shape memory device. Aptly, the process involves die-drawing a cannulated billet through a die which includes a mandrel that defines the profile and dimensions of the cannulation in the programmed material (i.e. Shape B of FIG. 1).

The initial polymer billet can be made using processes such as: compression moulding, injection moulding, ram injection moulding and extrusion. The billet can be formed by these processes with the initial cannulation in it, or alternatively it can be formed as a solid without cannulation and then the cannulation formed by processes such as drilling, machining, broaching and other similar methods.

In one aspect, the present invention relates to cannulated devices comprising an SMP material component. Aptly, the cannulated device is obtainable by the methods described herein. Aptly, the cannulated SMP material devices could be used in non-medical applications such as any mechanical fastener like a screw that requires the internal shaped cannulation. Such devices may have useful application in, for example, the rapid disassembly and assembly of devices in which SMP fasteners are used to hold a device together.

Some of the advantages of embodiments of the present invention are described above. This process can form a device with a controlled shaped/sized cannulation. The process can be continuous or semi-continuous to produce long lengths of cannulated rods that then then be cut to length and further shaped or otherwise converted into appropriate devices. In contrast, processes such drilling produce only circular cross-section holes (no use for a screw driver) and cannot produce long lengths of rod. Processes such as machining or broaching can produce shaped holes but again are not continuous and cannot produce long lengths of rod.

Drilling, machining, broaching and the like also all produce heat that will tend to activate a temperature sensitive SMP material—especially one with a low activation temperature such as used in a medical device.

In one aspect of the present invention, there is provided a method of forming a device or component comprising a composition comprising a matrix and SMP material fibers wherein the method comprises the use of a hot compaction process. Hot compaction is a process for producing highly oriented polymer materials. These are assembled and compacted under applied pressure and temperature.

In one aspect, the present invention relates to a shape memory material/device made by a hot compaction process. Aptly, the device is obtainable by a method described herein.

At the right compaction temperature the surface of the fibres melts, but not the bulk, maintaining most of the molecular orientation. On cooling, a composite is formed of the original oriented material in a matrix of the melted phase.

Aptly, materials e.g. the SMP material fibers may be prepared with different fibre/tape lay-ups; for example 0/90°, ±45° or any other lay-up. In this way shape changes in different directions may be built into the material.

It is possible to combine two fibres/tapes with different transition temperatures and compact them in the same or in different directions. This could give different shape changes at different temperatures. One use of this could be to make a reversible material.

Aptly, an interleaved film is added to widen the processing window and improve bonding.

Aptly, a stiffer reinforcement fibre (e.g. glass, carbon etc) is co-woven with the SMP material fibers.

A sheet of the material could be thermoformed into more complex shapes which undergo a shape change. For example they could be shrunk onto something else.

Materials prepared according to the invention, although described in the context of medical devices will also have other, non-medical, applications.

Fibre/tape extrusion and drawing is a fast, high volume industrial scale process. The hot compaction process is used commercially to make high strength/stiffness materials e.g. for suitcases, car panels etc. Therefore compared to other processes this method has the potential to produce SMP materials at high volume.

Another advantage of embodiments of the present invention is the ability to mix different materials either with the same or different transition temperatures, with lay-ups in different directions. This gives the ability to give multiple shape changes, including a reversible material, and/or to give shape changes in multiple directions.

In one aspect of the present invention, there is provided a method of forming a device comprising a SMP material component and a non-SMP material component, the method comprising moulding one or more components onto a surface of a programmed SMP component.

In a further aspect of the present invention, there is provided a device which comprises an SMP portion and a non-SMP portion, wherein said non-SMP portion is moulded onto the SMP portion.

The shape memory component and the moulded non-shape memory component may be the same material or different materials. The shape memory component may, in alternative embodiments, be formed on the exterior of the device.

Aptly, the device is for medical use. Alternatively, the device is for non-medical applications. Aptly, the device is a screw or a fastener.

Aptly, for a medical device application the transition temperature for the SMP component is in the range 30° C. to 90° C., e.g. in the range 35° C. to 80° C. and optionally in the range 37° C. to 50° C. The non-shape memory component preferably has a softening point (e.g. glass transition temperature or melting point) at or below the transition temperature of the SMP component, so as to minimise restriction of recovery of the SMP. Alternatively the stiffness of the non-SMP component may be much less than that of the SMP component.

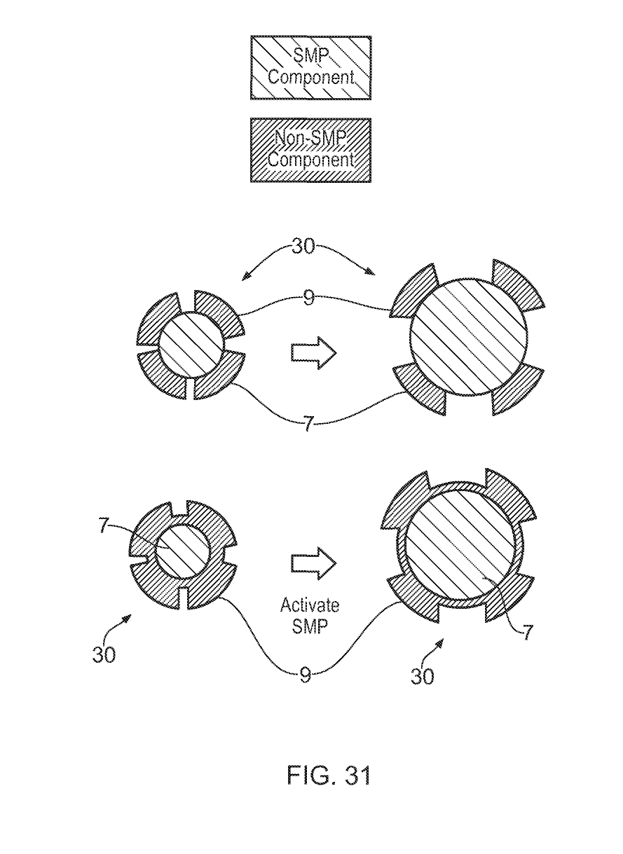

An alternative way to minimise the effect of the non-SMP component from restricting shape change of the SMP component is to incorporate thinner regions or gaps in the outer non-SMP component as shown in FIG. 31 below.

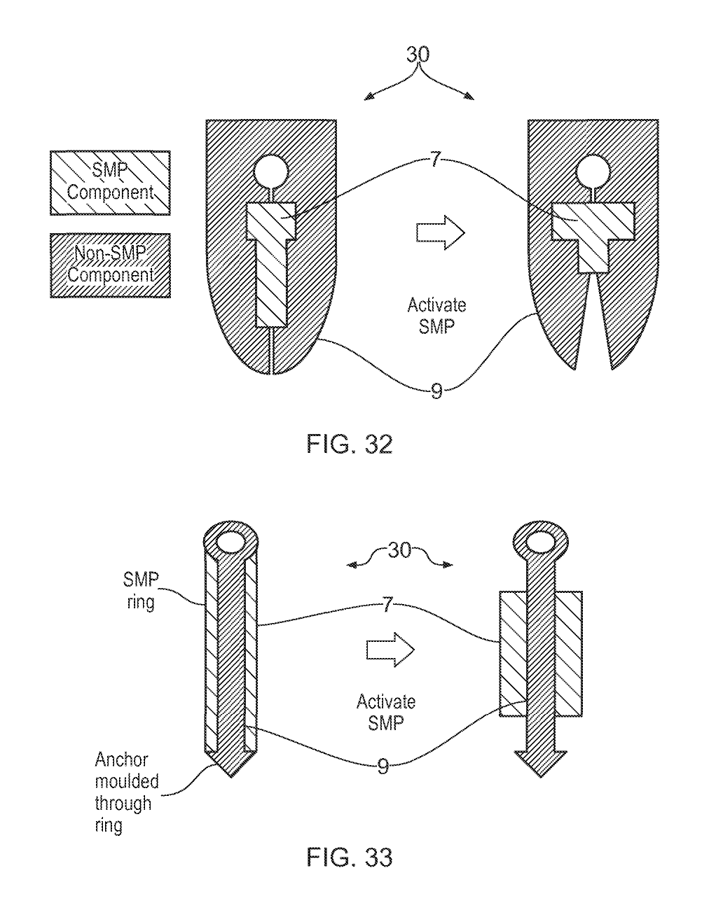

The SMP component may also be used to open an overmoulded non-SMP component on activation as shown in the anchor design in FIG. 32.

Rather than moulding features on the outside of an SMP material core, the moulded features may be moulded through a ring comprising an SMP material such as in the anchor design shown in FIG. 33.

The devices may also combine more than one shape memory component. For example, the shape memory components may have different shapes, different activation temperatures and/or different orientations.

In one embodiment, the shape memory component could be a shape memory metal e.g. nitinol. In one embodiment, the non-SMP component comprises a metal and the method comprises metal injection moulding. In one embodiment, the method is for the manufacture of an all metal device.

Compared to other methods of shaping SMP devices such as machining or expansion moulding, injection moulding is a fast process which lends itself to cost effective industrial scale production. It can be used to generate complex shapes. The process can easily combine different materials with different compositions including shape-memory components with different orientations, activation temperatures, shapes and the like.

Aptly, the medical devices made by the processes of the present invention are for implantation in a programmed state and, when desired, activated so as to recover its original state. As usual herein, the term ‘recover’ can be interchanged with the term ‘relax’ i.e. the SMP material returns to the shape it had prior to programming.

### EXAMPLES

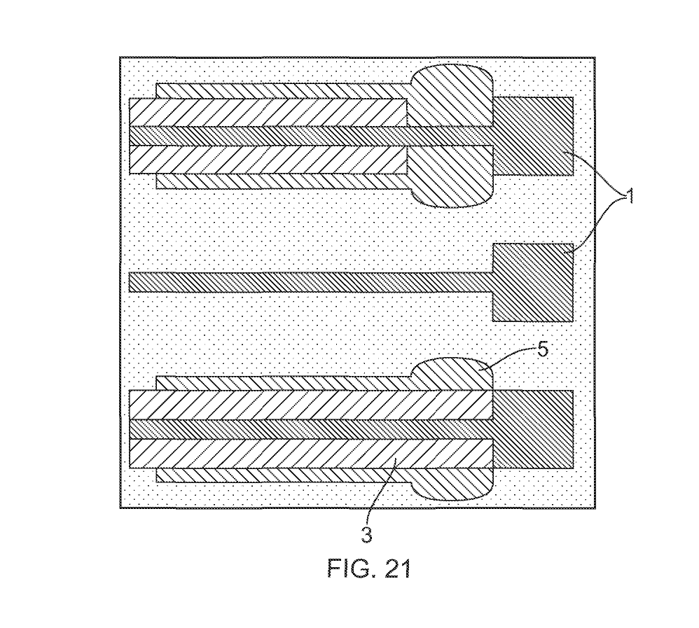

FIG. 21 illustrates two apparatus which can be used to produce a SMP screw, tack or anchor. The apparatus include a metal former 1. The pre-programmed SMP material rod is indicated by reference numeral 3, and the overmoulded non-shape memory polymer 5.

### Example 1

### Formation of Overmoulded Components

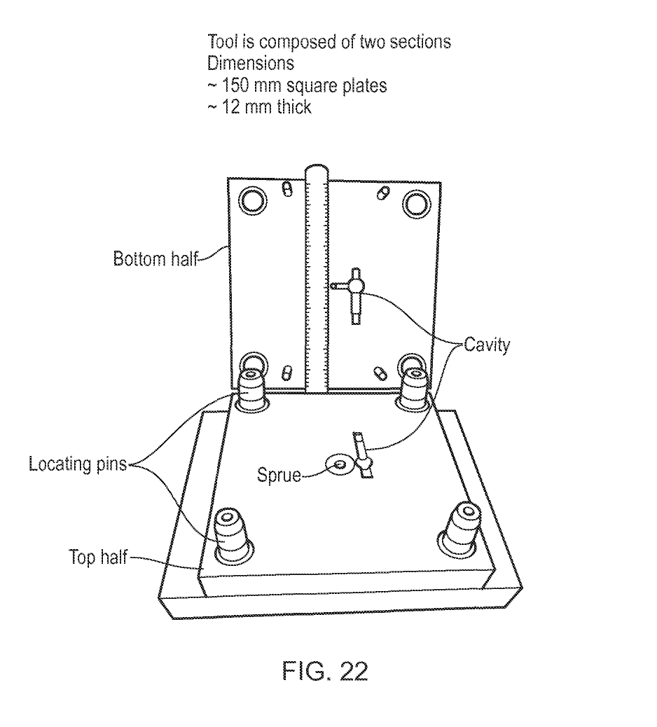

An overmoulding tool was produced which was composed of two sections. Each section comprised a 150 mm square plate having a thickness of approximately 15 mm made from steel. The top section includes locating pins which locate in corresponding locating orifices in the bottom section. The tools are illustrated in FIGS. 22 and 23.

A polyurethane (PU) billet (Elast-Eon E4 (Var 3) supplied by AorTech International plc) was die-drawn to a draw ratio of 4:1. The polyurethane die-drawn rod was then placed in the mould and overmoulded with the same PU polymer using a Cincinnati Milacron injection moulding machine to make complexly shaped SMP devices.

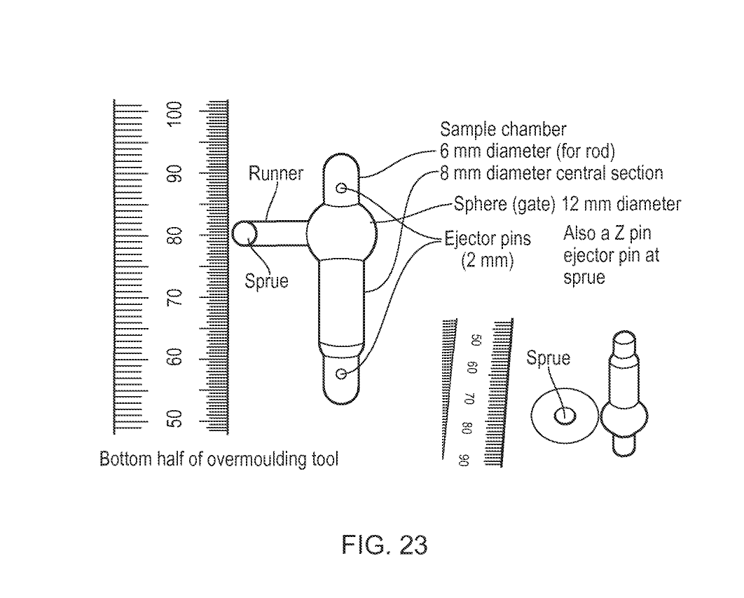

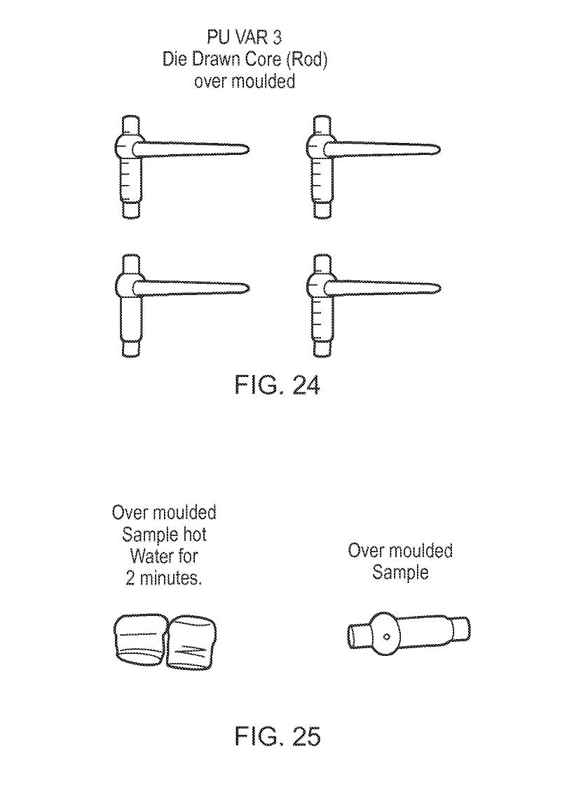

These devices were placed in hot water for two minutes and the SMP material component was shown to undergo a transition with substantial recovery of its original shape. The devices pre and post relaxation are illustrated in FIGS. 24 and 25.

### Example 2

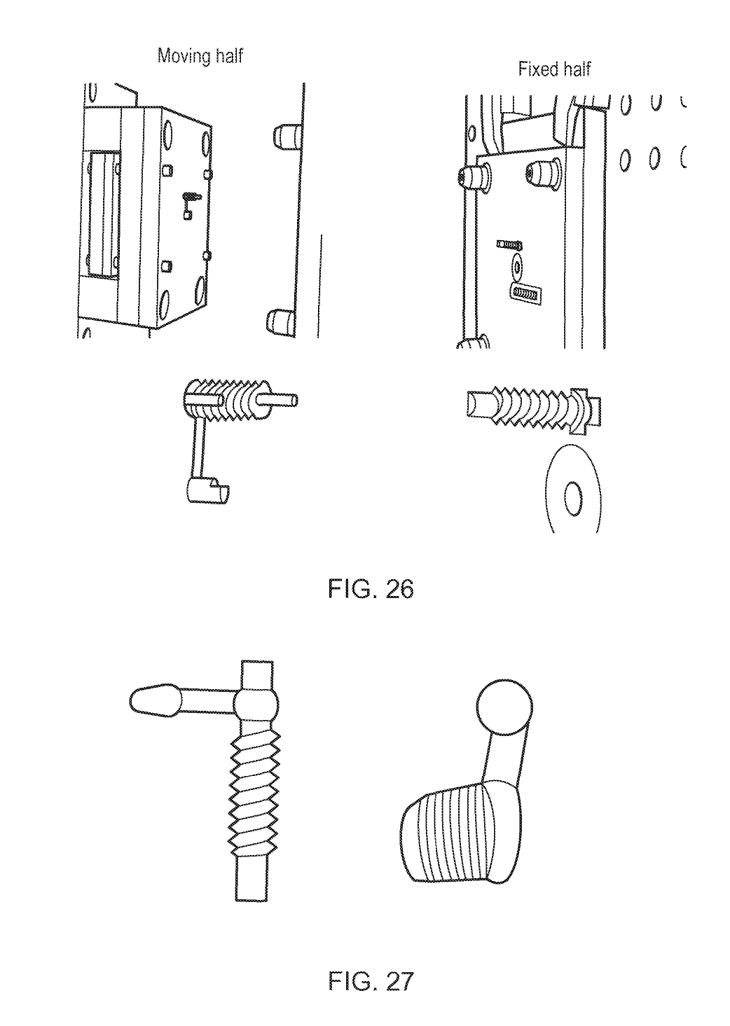

An over-moulding tool for a screw with a thread was made from steel as shown in FIG. 26. A length of the PU die-drawn billet was placed in the mould and overmoulded with the same PU polymer using the Cincinnati Milacron injection moulding machine to produce an overmoulded screw. Immersion in hot water again showed shape recovery of the over-moulded screw (FIG. 27).

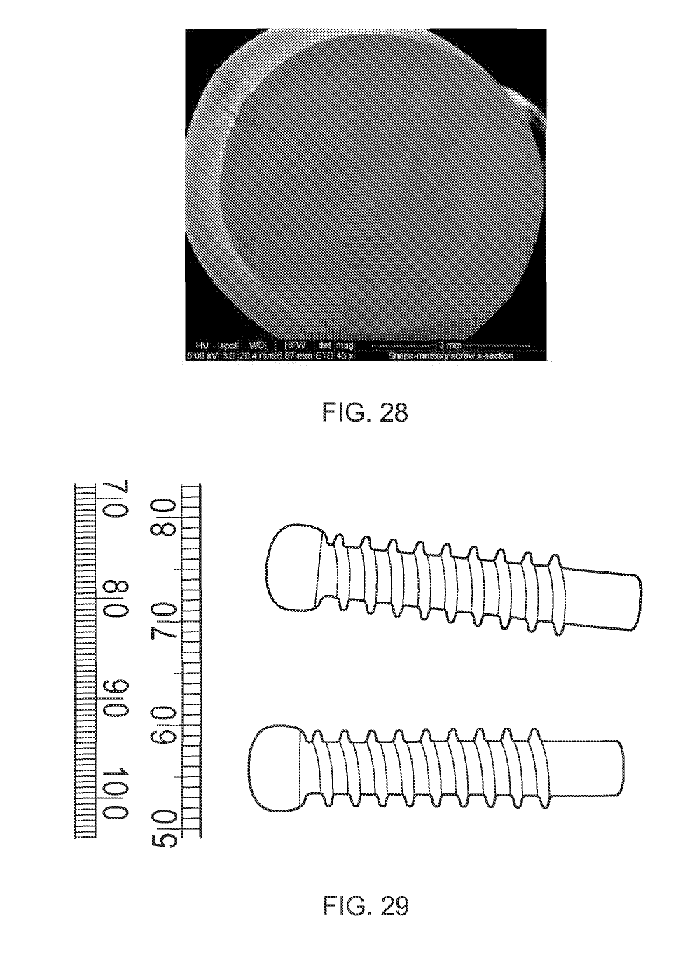

A screw made in this way was cut in half and polished with diamond paste to reveal its cross-section. This was examined using scanning electron microscopy. No boundary was visible between the die-drawn SMP rod and the overmoulded polymer (FIG. 28).

### Example 3

Poly(L-lactide-co-D,L-lactide 70:30 IV=3.8 (PLDL-7038 provided by Purac Biomaterials) was compounded with 4.4 wt % caprolactone. The resulting polymer was melt extruded at 170° C. into a cylindrical cannulated billet with outer diameter 9.9 mm. This billet was then die-drawn through a 5 mm die over a 3 mm hexagonal mandrel at either 64° C. or 60° C. Lengths of the resulting die-drawn cannulated rod were placed in the screw thread mould and over-moulded with the same polymer using the Cincinnati Milacron injection moulding machine with a temperature of 190° C. in the barrel rising to 225° C. at the nozzle. The method resulted in the production of cannulated screws, shown in FIG. 29.

### Example 4

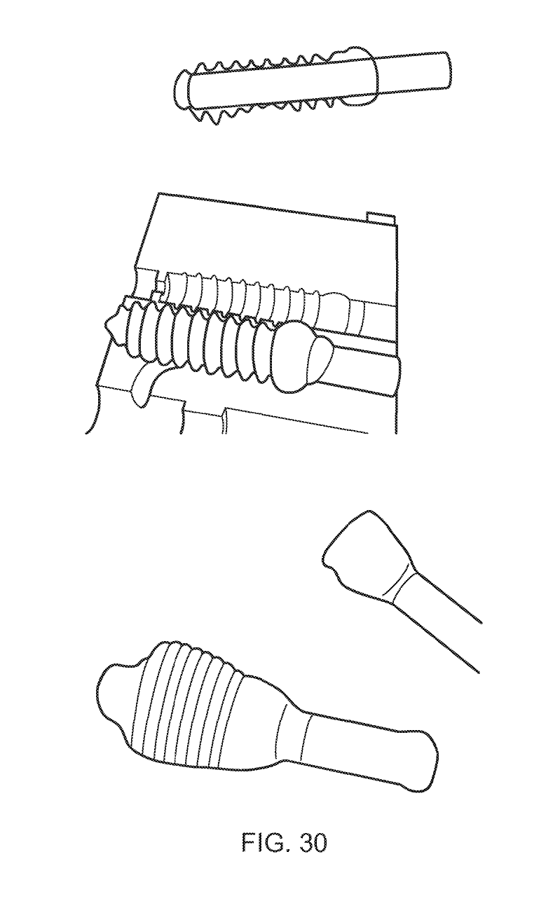

Poly(L-lactide-co-D,L-lactide 70:30 IV=3.8 (PLDL-7038 provided by Purac Biomaterials) was melt extruded into a cylindrical billet with outer diameter 9.9 mm. This billet was then die-drawn through a 5 mm die to give a draw ratio of 4:1. Polycaprolactone (CAPA 640 provided by Purac Biomaterials) was heated and injected into a screw mould (at room temperature). A length of die-drawn rod was pressed into the mould, the mould was clamped shut and placed in an oven at 110° C. for 5 minutes. The screw with moulded on threads was removed from the mould and polycaprolactone was found to comprise 37 wt % of the total weight of the screw. The screw was immersed in hot water (˜80° C.) to melt the polycaprolactone and induce recovery of the shape-memory die-drawn rod. The screws produced are illustrated in FIG. 30.

### Example 5

A shape memory polymer was programmed by ram extrusion (FIG. 2A (right hand side). A polyurethane cylindrical billet (ElastEon, supplied by AorTech plc) with 30 mm diameter was ram extruded through a die of diameter 21.2 mm (draw ratio 2:1) at a speed of 10 mm/min at temperatures of 72° C. and 90° C.

An alternative related process is compression transfer moulding (FIG. 2B left hand side) which has the additional advantage of being able to produce cannulated rods.

### Example 6

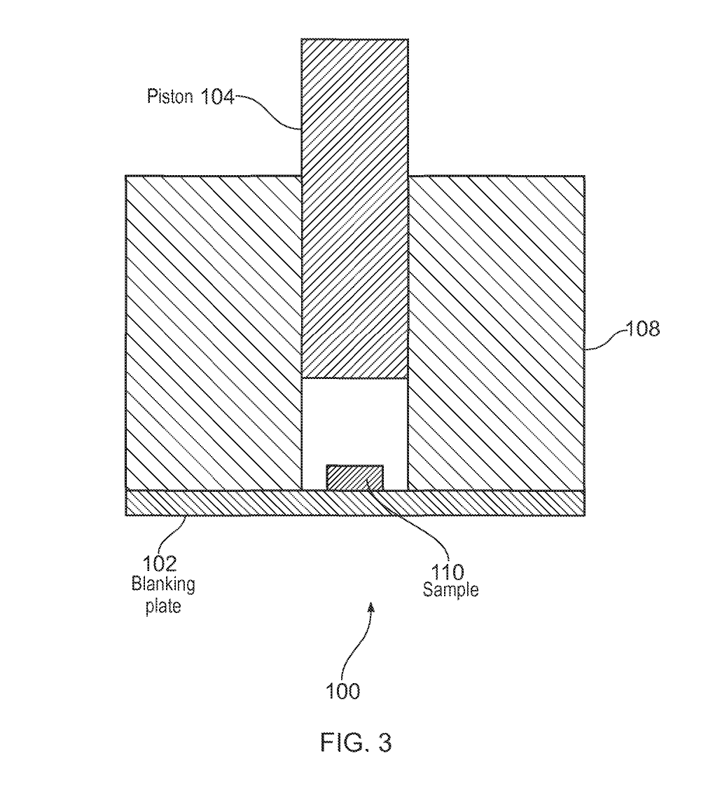

A shape memory polymer was programmed by compression shaping/forging. The material was deformed radially with side constraints to give shape (FIG. 3). A polyurethane cylindrical billet (ElastEon, supplied by AorTech plc) with 15 mm diameter was compressed in a chamber with diameter 30 mm (compression ratio (initial height:final height)=4:1) at a temperature of 85° C. and piston speed of 10 mm/min.

### Example 7

A shape memory polymer was programmed by forging/pressing. The material was deformed radially without side constraints in a press. A polyurethane cylindrical billet (ElastEon, supplied by AorTech plc) with 30 mm diameter and 5 mm height was heated in an oven and then transferred to a press. A load of 430N (equivalent to 600 MPa) was applied with a platen speed of 100 mm/min. The processing temperature was either 85° C. or 102° C.

### Example 8

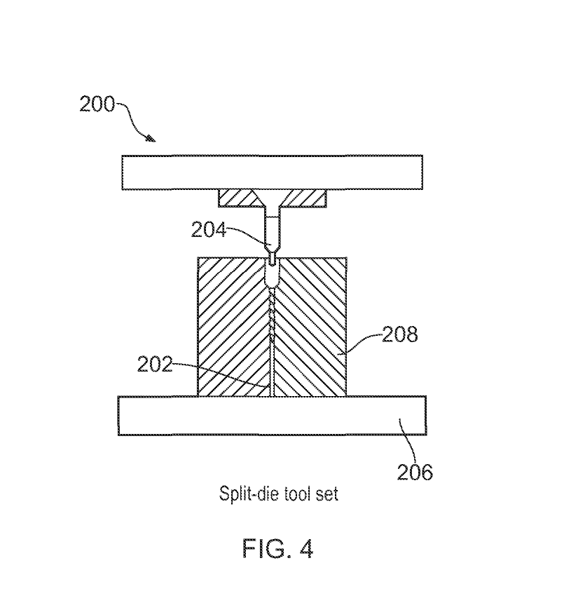

A SMP may be programmed by radial forging. A simple billet is heated and forced into a mould. For example, a tool for producing an interference screw is shown in FIG. 4.

### Example 9

A SMP may be programmed by cold forging. A simple shaped unoriented polymer billet (e.g. cylinder, possibly with tapered end) could be placed in a mould (such as that shown in FIG. 5) and pressed (with or without applied temperature) to form a complex shape (such as that of a screw).

This method has the advantage of producing complex shapes in one processing step.

### Example 10

Poly(D,L-lactide-co-glycolide) 85:15 (provided by Purac Biomaterials) was compounded with 35% w/w calcium carbonate. The polymer was then moulded into cylindrical cannulated billets and die drawn to give a draw ratio of 4:1 with a final outer diameter of 7 mm.

A Bio-RCI 7×35 mm screw mould was used (FIG. 13). 35 mm lengths of the die-drawn rod were cut and the tips of the rods tapered slightly to give a better fit in the tapered end of the mould. A 3.2 mm hex key was fitted into the cannulation.

Two lengths of prepared rod were placed in the mould—with one in each side of the mould. The mould was closed with 20 tons of pressure using a hydraulic press. The pressure was released immediately and the screws removed. The flash was trimmed from the screws and the screws returned to the mould. This process was repeated four times to produce screws with a good surface finish.

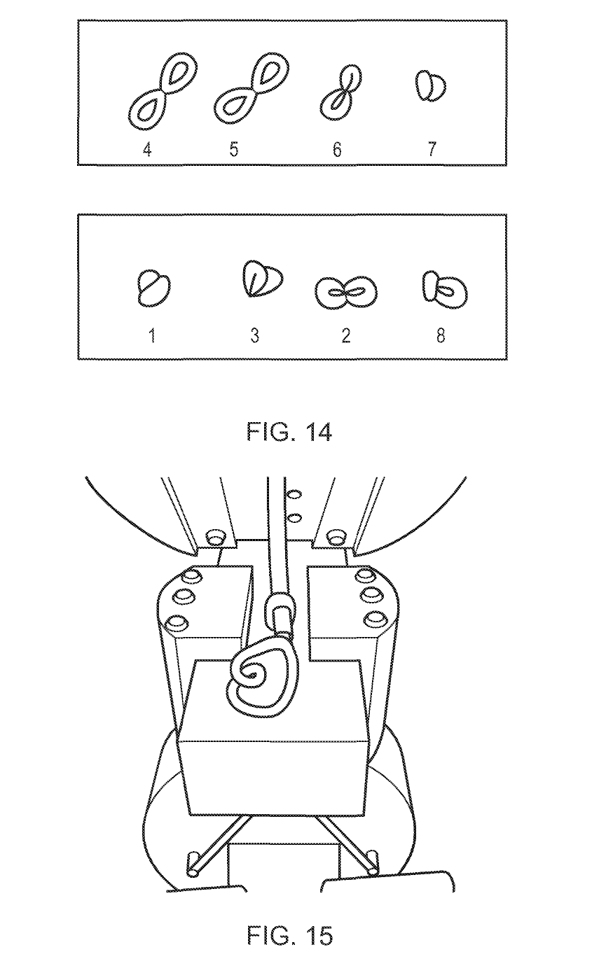

Blocks of Sawbones™ (Sawbones Europe AB) (10 and 20 pcf) were cut in half, length ways, using a band saw and 8.5 mm diameter holes were drilled in the Sawbones using a pillar drill, ensuring a distance of 2.5 cm from all edges and adjacent holes (see FIG. 14).

Lengths of braid (Nylon braided rope ⅛″ diameter ex Bridgeline Ropes Inc) were soaked in water for approximately 30 minutes. Two pieces of the wet braid were inserted into each hole in the Sawbones. The braid was doubled over so that two loops of braid protruded from one end of the screw hole and four loose ends of the braid from the other. The cold-forged screws were screwed into the Sawbones between the four loose ends of the braid, trying to ensure that the four loose ends were kept separated from one another as the screw was inserted. All screws were screwed into the Sawbones using a hex key (3.2 mm).

Five screws in each type of Sawbones were tested before relaxation (10 screws in total) and five screws in each type of Sawbones were tested after complete relaxation (10 screws in total).

Activation of the SMP screws was achieved by storing the screw/Sawbones construct in water in an oven set at 80° C. for several hours. These were then left to cool and dry over night before mechanical testing. All screws to be tested before relaxation were also left overnight for the braid to dry.

Mechanical pull-out testing of the ACL screws was carried out using an Instron 5566 with a 10 kN load cell and Bluehill software.

The Sawbones blocks were slotted into a custom made fixture that was held in the lower grip and in the upper grip an Allen key was fixed. The loops of braid were looped over the Allen key and this was used to pull the screw from the Sawbones (see FIG. 15).

The testing was carried out with a rate of 25 mm/minute with a pre-load of 22 N (5 lbf) before measurements began. Tests were ended after a significant drop in load was observed that could be associated to movement within the screw/Sawbones construct. The failure point was selected using a cursor point.

The results of the pull-out tests are presented in Table 1.

TABLE 1
Results of pull-out tests of both before relaxation and after relaxation

| | Sawbones | | Pull-out | |
|---|---|---|---|---|
| | Type | | Force | |
| Sample | (pcf) | Activated | (N) | Observations |
| 1 | 10 | No | 227.49 | Braid pulled out |
| 2 | | | 327.34 | Screw pulled out |
| 3 | | | 373.38 | Screw pulled out |
| 4 | | | 328.59 | Braid pulled out |
| 5 | | | 219.91 | Braid pulled out |
| Average | | | 295 ± 68 | |
| 1 | 20 | No | 939.50 | Screw pulled out |
| 2 | | | 766.98 | Braid pulled out |
| 3 | | | 846.64 | Screw pulled out |
| 4 | | | 845.22 | Braid pulled out |
| 5 | | | 816.68 | Braid pulled out |
| Average | | | 843 ± 63 | |
| 1 | 10 | Yes | 407.75 | Sawbones failed |
| 2 | | | 377.44 | Sawbones failed |
| 3 | | | 454.80 | Braid pulled out |
| 4 | | | 469.44 | Screw pulled out |
| 5 | | | 428.12 | Screw pulled out |
| Average | | | 428 ± 37 | |
| 1 | 20 | Yes | 924.82 | Braid pulled out |
| 2 | | | 645.65 | Braid pulled out |
| 3 | | | 819.66 | Screw pulled out |
| 4 | | | 485.29 | Braid pulled out |
| 5 | | | 1014.08 | Braid pulled out |
| Average | | | 778 ± 213 | |

The results indicate that reducing the density of the Sawbones dramatically reduced the force required to pull the screw from the Sawbones/braid construct. The measured fixation of the cold forged screws in the 10 pcf Sawbones was similar to the value measured for machined screws in the same density Sawbones (302 N). Relaxation of the shape memory screws did improve the fixation in the 10 pcf Sawbones, however, no significant effect was observed in the 20 pcf Sawbones.

### Example 11

Poly(L-lactide-co-D,L-lactide) 70:30 IV=3.8 (Purasorb PLDL 7038, from Purac Biomaterials) was compounded with 5% caprolactone as a plasticiser to give a glass transition temperature of around 47° C. The polymer was moulded into cylindrical billets and die-drawn to a ratio of 4:1 over a hexagonal mandrel. The billets were cut into lengths of approximately 35 mm with a 7 mm outer diameter and an approximately 3.2 mm internal diameter (hexagonal hole). The end of the rod was tapered to fit the shape of the screw mould using a pencil sharpener. The Bio-RCI 7×35 mm mould described above was used. Rods were placed into the die and moulded as described in Example 10.

The screws were implanted into ovine cadaver tibias and femurs in an anterior cruciate ligament (ACL) reconstruction technique. The extensor tendons were first harvested and stored in moist gauze until required. All soft tissue around and within the joint was then removed including the ACL, posterior cruciate ligament (PCL) and menisci. Tibial bone tunnels were drilled with a diameter of 8 mm. Femoral bone tunnels were drilled with a diameter of 8.5 mm. The medial extensor tendons harvested at the start of the procedure were used in the tibial tunnels and the slightly thicker lateral extensor tendons were used in the femoral tunnels. All tendons were doubled over and fed into the bone tunnels. A 3.2 mm Allen key was then used to drive the screws into the bone tunnels.

To achieve shape change, the bone samples containing the screws were sealed in a container of water which had been heated to 37° C. These containers were then placed back in an oven set at 37° C. and left for 24 hours. After 24 hours the bone samples were removed from the oven and water and stored at 4° C. for approximately one hour before testing was begun.

Mechanical testing of the implanted screws was carried out on an electromechanical Instron 5566 tensile testing machine. A 10 kN load cell was positioned in the crosshead of the electromechanical Instron and a wedge face grip attached. An Allen key was placed in the grip to be used to pull the tendon during testing.

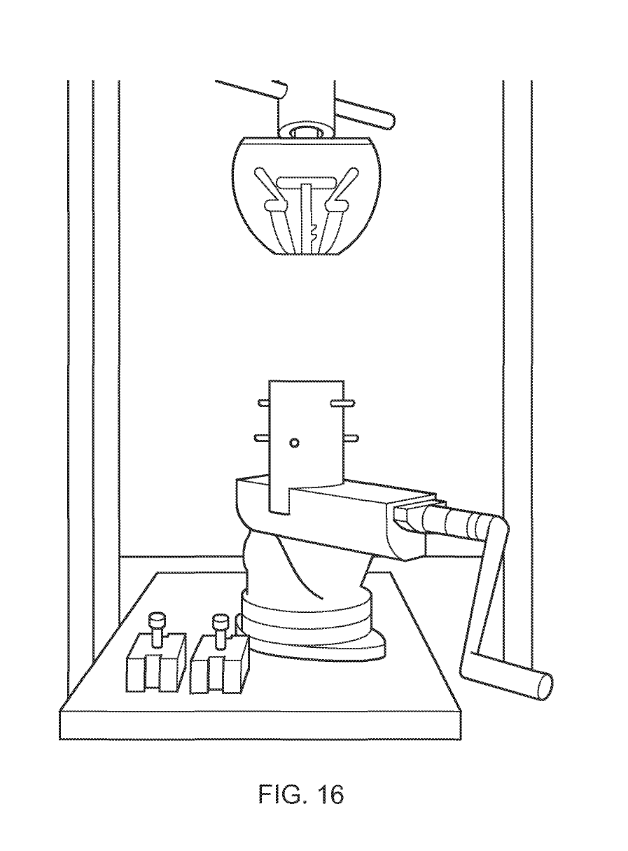

A metal base plate was fixed to the base of the Instron and on top of this was placed a multi axis vice (see FIG. 16). The base plate allowed the multi axis vice to be bolted in place once alignment had been achieved to prevent the vice from lifting during pull-out testing.

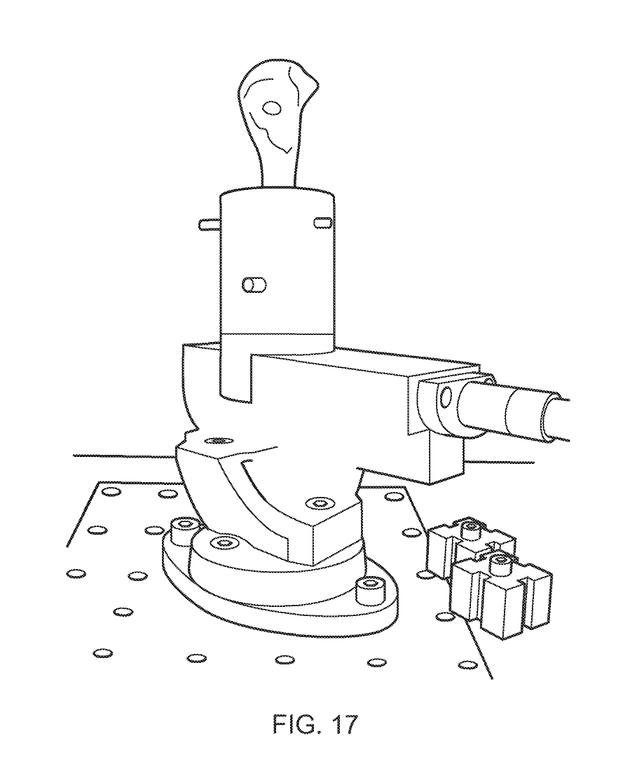

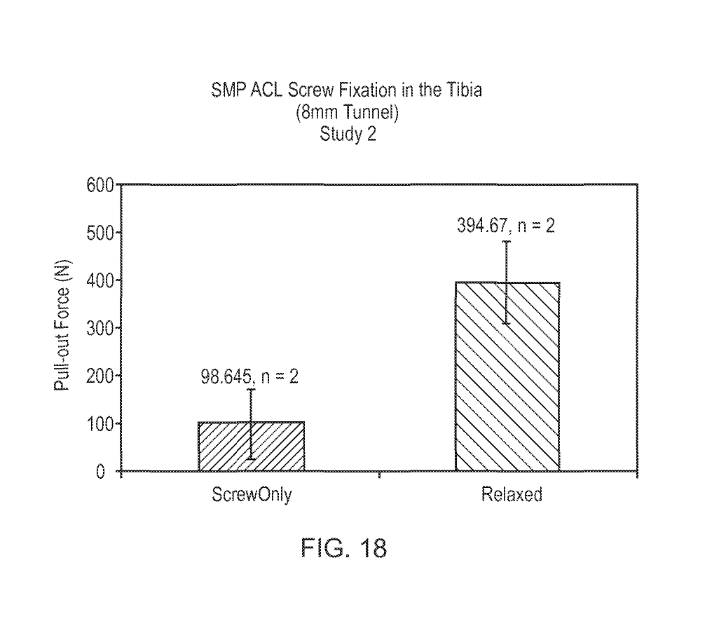

To hold the bone securely while the tendon was being pulled, the bones were gripped in a “Christmas tree fixture” (see FIG. 17). Small screws in this fixture that surround the bone were tightened to fasten the bone in place. This fixture was then gripped in the multi axis vice.

The axis of the bone tunnel was positioned parallel to the axis of the supplied load using a guide wire. Once the cannulation was aligned with the loading axis the vice was securely fixed to the base plate. The tendon was looped over the Allen key in the grip and testing was started.

Bluehill software was used to control testing at a rate of 60 mm/min with a pre-load of 22 N (5 lbf) before measurements began. Tests were ended after a significant drop in load was observed that could be associated to movement of the screw or tendon. The failure point was selected using a cursor point.

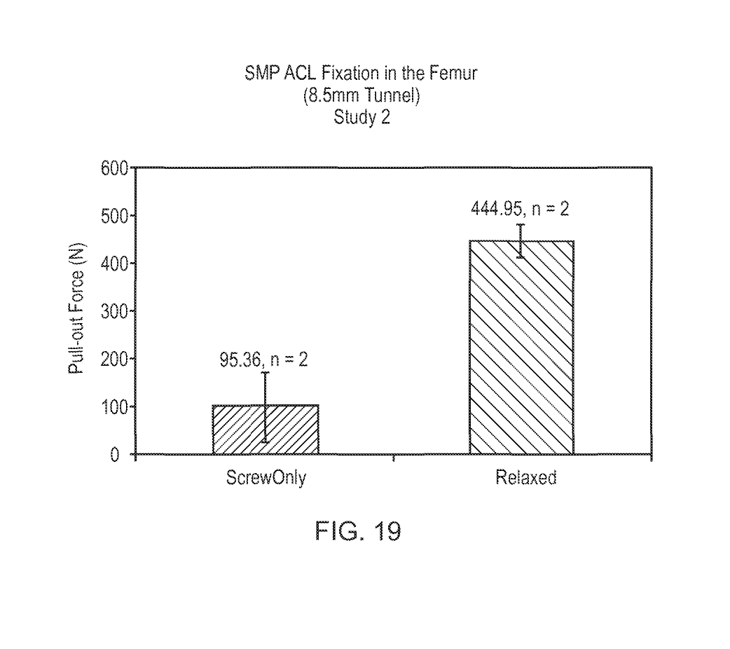

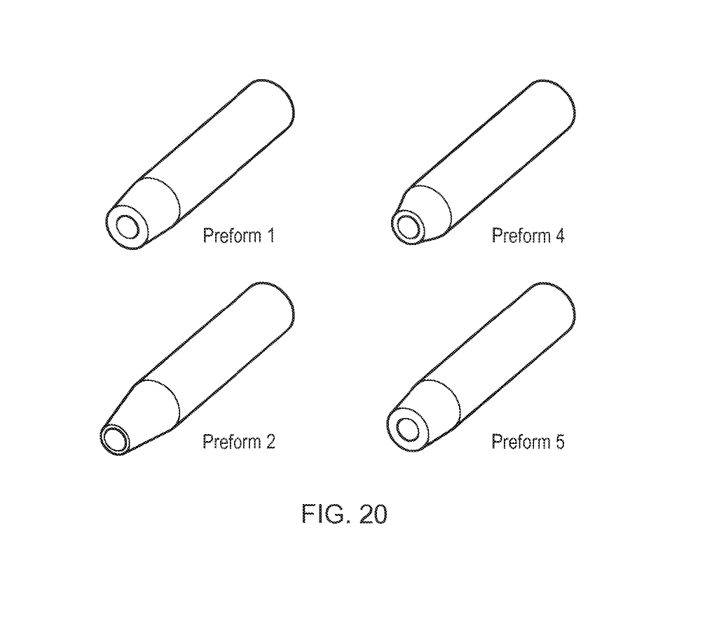

Results for the tibia (8 mm tunnel) are shown in FIG. 18 and results for the femur (8.5 mm tunnel) in FIG. 19. Average peak pull-out forces in the tibia and femur were similar regardless of the difference in tunnel size. Peak pull-out force in both the tibia and femur is significantly increased after shape change (relaxation).

### Example 12

FIGS. 5 and 6 show a tool for cold forging of a shape memory polymer 7 mm×30 mm interference screw. The mould tool comprises a lower die and an upper die together with a core pin to develop and maintain the internal detail of the screw. The tool also has inlets for liquid to heat or cool the mould.

### Example 13

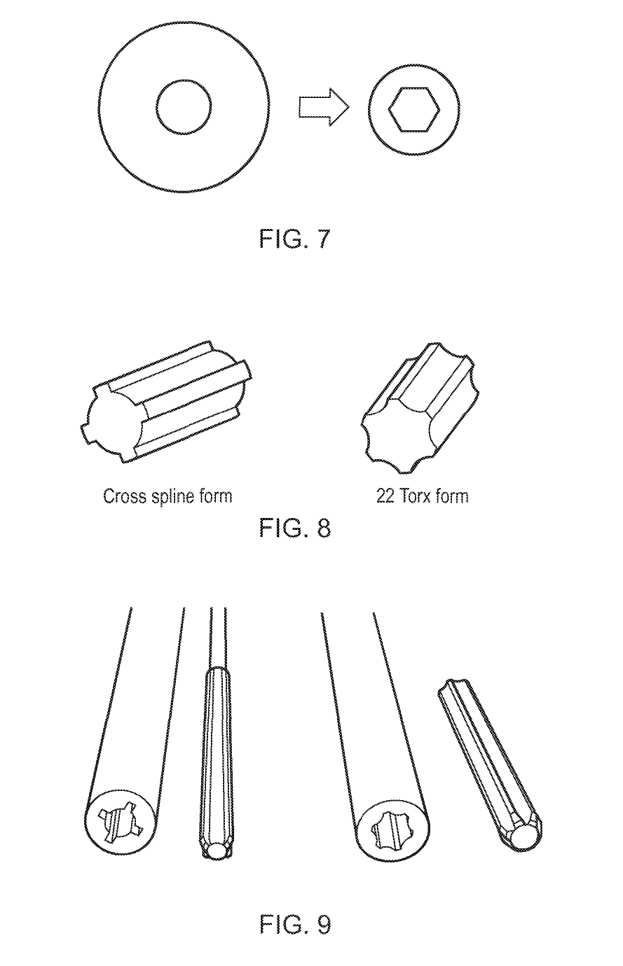

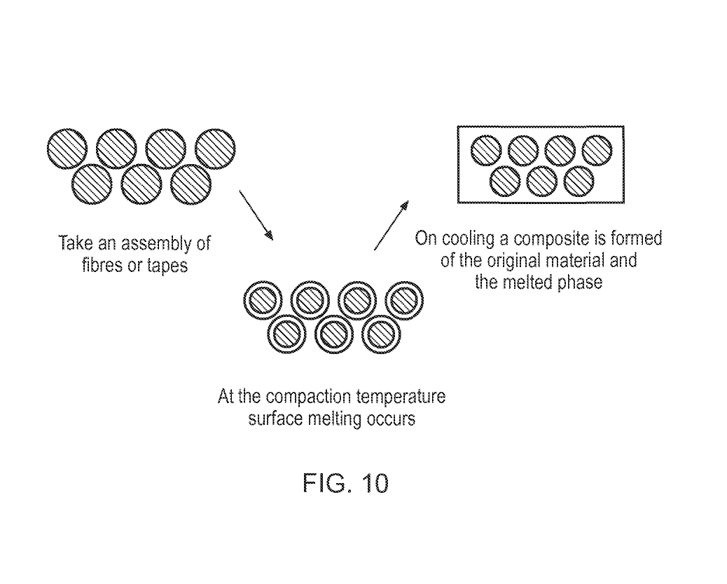

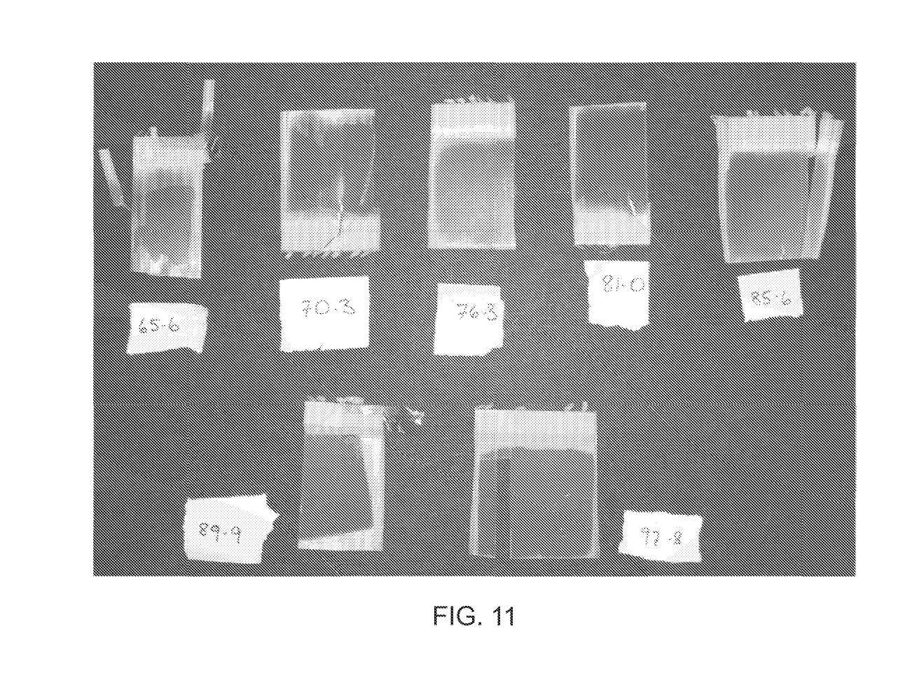

A polymer composite billet of poly(lactide-co-glycolide) 85:15 containing 35% w/w calcium carbonate was prepared by ram injection moulding using a mould with a central circular cross-section pin to produce an initial cannulation. The billet had an outer diameter of 14 mm and a 4 mm diameter central hole. This billet was drawn down to 7 mm outer diameter over a 3 mm hexagonal mandrel. A schematic representation of the cannulated billets before and after being die drawn is shown in FIG. 7.

### Example 14

A billet as in Example 13 was drawn down to 7 mm outer diameter over a cross spline form mandrel of approximately 3.5 mm diameter.

### Example 15

A billet as in example 13 was drawn down to 7 mm outer diameter over a Torx form mandrel of approximately 3.5 mm diameter.

The final cannulation can be any shape in cross-section including, but not limited to: circle, oval, triangle, square, rectangle, hexagon, spline, star, cross.

### Example 16

A polyurethane (ElastEon, Aortech plc) having a glass transition temperature (Tg) of about 65° C. was extruded using a single screw extruder at 200° C. on to hot rollers set at 100° C. The tape was drawn over a hot shoe set at 85° C. The drawn tape was wound around a metal frame so that the tapes were just overlapping in a unidirectional arrangement. The tape arrangement was loaded into a hot press (between aluminium sheets) set at the desired temperature. A pressure of 5 MPa was applied and when the assembly had reached the correct temperature cooled immediately. Compaction temperatures from 65-98° C. were used. The resulting samples are shown in FIG. 11.

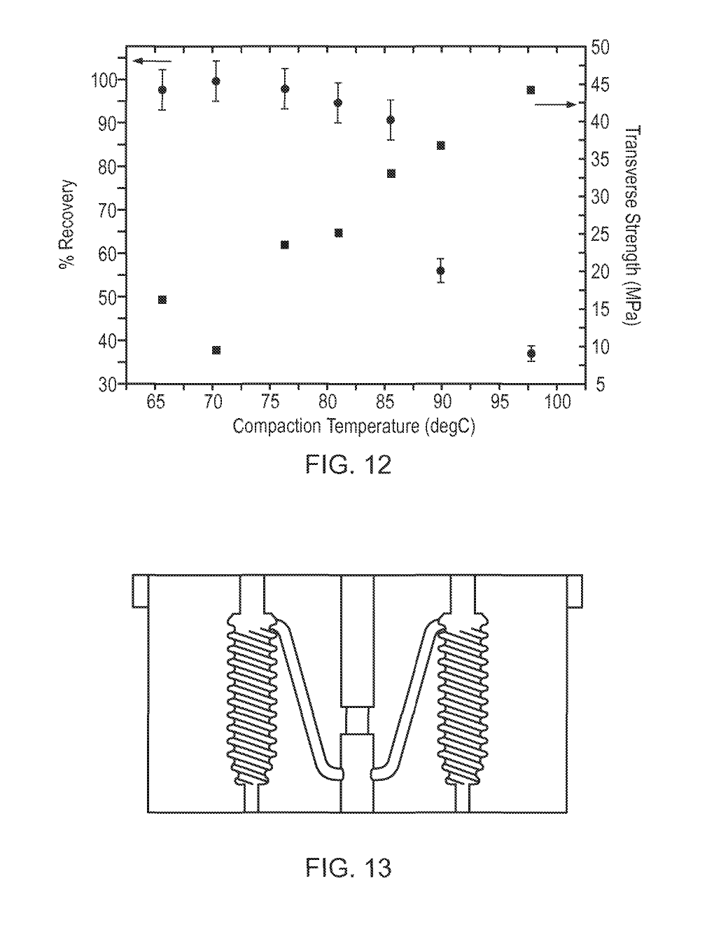

The % recovery and transverse strength were measured and the results shown in FIG. 12.

Transverse strength increased with compaction temperature. There was almost complete recovery of the material up to a compaction temperature of 85° C. when the recovery dropped rapidly.

The optimum compaction temperature was therefore identified as 83±2° C. The sample made at optimum conditions had a 90% length recovery and a transverse strength of 35 MPa, showing excellent bonding of the tapes.

Materials may be prepared with different fibre/tape lay-ups; for example 0/90°, ±45° or any other lay-up. In this way shape changes in different directions may be built into the material.

Throughout the description and claims of this specification, the words “comprise” and “contain” and variations of them mean “including but not limited to” and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of the features and/or steps are mutually exclusive. The invention is not restricted to any details of any foregoing embodiments. The invention extends to any novel one, or novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1-58. (canceled)

59. A method of manufacturing a component having at least in part a shape memory polymer (SMP) material or a device having at least in part a SMP material, the method comprising applying a predetermined pressure to a SMP material prior to, at substantially the same time or subsequent to programming the polymer material to impart shape memory properties to the SMP material.

60. The method according to claim 59, further comprising placing a SMP material in a mold and applying pressure thereto.

61. The method of claim 59, which comprises programming the SMP material to impart shape memory properties thereto and form an SMP material; placing the SMP material into a mold; and applying a pressure to the mold.

62. The method according to claim 61, wherein the pressure is applied to the mold by a process of cold forging at a temperature below the glass transition temperature of the SMP material and wherein the temperature maintains the molecular orientation of the polymers of the SMP material.

63. The method according to claim 61, wherein the step of applying the pressure alters the dimensions of the SMP material.

64. The method according to claim 61, further comprising heating or cooling the mold before and/or at substantially the same time as applying the pressure to the mold.

65. The method according to claim 61, wherein the step of applying pressure comprises closing the mold with a hydraulic press.

66. The method according to claim 61, wherein the method is for forming a complex shaped component.

67. The method according to claim 59, further comprising a method of making a device comprising a channel of fixed dimensions, wherein the device comprises a shape memory polymer material, and wherein the method comprises fixing the dimensions of the channel at substantially the same time as programming the SMP material.

68. The method according to claim 59, further wherein the method forms a composition comprising a matrix and SMP material fibers, the method comprising:
a. applying the predetermined pressure to an assembly of SMP material fibers;
b. heating the assembly of polymer material fibers to a first predetermined temperature sufficient to melt or soften at least a portion of the fibers, wherein the first predetermined temperature is greater than the glass transition temperature of the polymer material; and cooling the fibers to form a composition comprising a matrix and the SMP material fibers.

69. The method according to claim 68, which comprises mixing the SMP fibers with non-SMP fibers.

70. The method according to claim 68, further comprising melting an outer layer of a portion of the SMP fibers.

71. The method of claim 59, which comprises programming the polymer material to impart shape memory properties occurs at substantially the same time as a step of shaping the polymer material.

72. The method of claim 71, which comprises:
a. heating the polymer material to a first predetermined threshold temperature prior to or at the same time as applying the predetermined pressure, wherein the predetermined pressure is applied so as to change an initial shape of the polymer material to a predetermined second shape having at least one surface;
b. feeding the SMP material through a die to form an SMP material component; and
c. cooling the SMP component to a second predetermined threshold temperature.

73. The method according to claim 72, wherein the first predetermined threshold temperature is above the glass transition temperature of the SMP material and/or the second predetermined threshold temperature is below the glass transition temperature of the polymer material.

74. The method according to claim 72, wherein the step (b) comprises ram extrusion and/or compression transfer molding.

75. The method according to claim 72, wherein the second predetermined threshold temperature is below the glass transition temperature of the SMP material.

76. The method according to claim 72, further wherein a non-SMP component is molded to the surface of the SMP component once the SMP component is programmed.

77. The method according to claim 76, which comprises placing the SMP material component in a mold and injection molding the non-SMP material into the mold to form the device, and wherein the predetermined pressure is applied upon injection of the non-SMP material into the mold.

78. The method according to claim 76, which comprises molding a noncontinuous layer of non-SMP material onto a surface of the SMP material component.

79. A method of manufacturing a device comprising a SMP material component and a non-SMP material component, the method comprising molding the non-SMP material component onto a surface of a SMP material component.

80. The method according to claim 79, which further comprises placing the SMP material component in a mold and injection molding the non-SMP material into the mold to form the device, and wherein the predetermined pressure is applied upon injection of the non-SMP material into the mold.

81. A method of manufacturing a device comprising a SMP material component and further comprising a channel of fixed dimensions, the method comprising fixing the dimensions of the channel at the same time or substantially the same time as programming a polymer material component so as to impart shape memory properties to the polymer material to form a SMP material component.

82. A method of forming a matrix comprising SMP material fibers comprising forming a composition comprising a matrix and SMP material fibers, the method comprising:
a. applying the predetermined pressure to an assembly of SMP material fibers;
b. heating the assembly of polymer material fibers to a first predetermined temperature sufficient to melt or soften at least a portion of the fibers, wherein the first predetermined temperature is greater than the glass transition temperature of the polymer material; and cooling the fibers to form a composition comprising a matrix and the SMP material fibers.

83. The method according to claim 82, wherein the SMP material comprises a polymer selected from poly(L-lactide) poly(D,L-lactide), polyglycolide, polycaprolactone, polydioxanone or a blend or copolymer thereof.

84. The method according to claim 82, wherein the SMP material comprises a polymer selected from: polyurethane, polyacrylate such as poly(methylmethacrylate), poly(butyl methacrylate), poly(ether ether ketone) (PEEK), and blends or copolymers thereof.

85. The method according to claim 82, wherein the SMP material comprises filler particles selected from the group consisting of at least one of a bioceramic filler including calcium phosphate, tricalcium phosphate, hydroxyapatite, brushite, and octacalcium phosphate, calcium carbonate, calcium sulphate, or a bioglass.

86. The method according to claim 82, wherein the SMP material comprise a plasticizer selected from the group consisting of DL-lactide, L-lactide, glycolide, ε-Caprolactone, N-methyl-2-pyrolidinone and a hydrophilic polyol including poly(ethylene) glycol (PEG).

87. The method according to claim 86, wherein the plasticizer is selected from is selected from DL-lactide, L-lactide, glycolide, ε-Caprolactone, N-methyl-2-pyrolidinone and a hydrophilic polyol including poly(ethylene) glycol (PEG).
